(19) United States
(12) Patent Application Publication
(10) Pub. No.: US 2025/0045945 A1
(43) Pub. Date: Feb. 6, 2025

(54) MULTI-STAGE REPROJECTION FOR SERVER-BASED EXTENDED-REALITY RENDERING

(71) Applicant: Varjo Technologies Oy, Helsinki (FI)

(72) Inventors: Mikko Strandborg, Helsinki (FI); Ari Antti Erik Peuhkurinen, Helsinki (FI)

(73) Assignee: Varjo Technologies Oy, Helsinki (FI)

(21) Appl. No.: 18/361,963

(22) Filed: Jul. 31, 2023

(51) Int. Cl. G06T 7/70; G06T 7/20; G06T 7/40; G06T 7/50

(52) U.S. Cl. CPC G06T 7/70; G06T 7/20; G06T 7/40; G06T 7/50

(57) ABSTRACT

A server is configured to receive first pose information of a pose of client device(s) over a first time period; estimate a first predicted pose; generate a first image according to the first predicted pose; receive second pose information of the pose of the client device(s) over a second time period; estimate a second predicted pose; generate a second image by reprojecting the first image from the first predicted pose to the second predicted pose; and send the second image to the client device(s). The client device(s) is configured to collect third pose information of the pose of the client device(s) over a third time period; estimate a third predicted pose; generate a third image by reprojecting the second image from the second predicted pose to the third predicted pose; and display the third image.

### TECHNICAL FIELD

The present disclosure relates to systems incorporating multi-stage reprojection for server-based extended-reality rendering. Moreover, the present disclosure relates to methods incorporating multi-stage reprojection for server-based extended-reality rendering.

### BACKGROUND

In recent times, there has been an ever-increasing demand for pose-consistent image generation. Such a demand may, for example, be quite high and critical in case of evolving technologies such as immersive extended-reality (XR) technologies, which are being employed in various fields such as entertainment, real estate, training, medical imaging operations, simulators, navigation, and the like. Such immersive XR technologies create XR environments for presentation to users of XR devices (such as an XR headsets, pairs of XR glasses, or similar).

However, existing equipment and techniques for generating pose-consistent images have several problems associated therewith. Typically, the existing equipment and techniques involve predicting a display time when an image frame is likely be displayed at an XR device, tracking a pose of the XR device, generating and sending the image frame to the XR device. Since there is always some delay (for example, due to communication network traffic, fluctuations in XR application rendering time, transmission delays, compression-related overheads, and the like) between measurement of the pose of the XR device and generation of the image frame corresponding to said pose, a more recent (i.e., latest) pose of the XR device is available by the time the generated image frame is ready for displaying. Additionally, an actual display time of the image frame may also differ from a predicted display time of the image frame. In such a scenario, the image frame is displayed at the XR device with a considerable latency and stuttering, even when reprojection of the image frame is performed prior to displaying it. Resultantly, this leads to a sub-optimal (i.e., unrealistic), non-immersive viewing experience for a user of the XR device, when the image frame is displayed to said user.

Therefore, in light of the foregoing discussion, there exists a need to overcome the aforementioned drawbacks.

### SUMMARY

The aim of the present disclosure is to provide a system and a method for generating pose-consistent, high-quality, and realistic images in a computationally-efficient and a time-efficient manner. The aim of the present disclosure is achieved by a system and a method which incorporates multi-stage reprojection for server-based extended-reality rendering, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of an architecture of a system incorporating multi-stage reprojection for server-based extended-reality (XR) rendering, in accordance with an embodiment of the present disclosure;

FIGS. 2 and 3 illustrate sequence diagrams showing operational steps of a system incorporating multi-stage reprojection for server-based XR rendering, in accordance with different embodiments of the present disclosure;

FIG. 4A illustrates how a cone angle map is utilized for performing ray marching, while FIG. 4B illustrates a comparison between a typical cone angle and a relaxed cone angle for a given texel, in accordance with an embodiment of the present disclosure; and

FIG. 5 illustrates steps of a method incorporating multi-stage reprojection for server-based XR rendering, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a system comprising at least one server that is communicably coupled to at least one client device, wherein the at least one server is configured to:
receive, from the at least one client device, first pose information indicative of at least a pose of the at least one client device over a first time period;
estimate a first predicted pose corresponding to a future time instant, based on the first pose information;
generate a first image according to the first predicted pose;
receive, from the at least one client device, second pose information indicative of at least the pose of the at least one client device over a second time period that ends after the first time period;
estimate a second predicted pose corresponding to the future time instant, based on the second pose information;
generate a second image by reprojecting the first image from the first predicted pose to the second predicted pose using a first reprojection algorithm; and
send the second image to the at least one client device, wherein the at least one client device is configured to:
collect third pose information indicative of at least the pose of the at least one client device over a third time period that ends after the second time period;
estimate a third predicted pose corresponding to the future time instant, based on the third pose information;
generate a third image by reprojecting the second image from the second predicted pose to the third predicted pose using a second reprojection algorithm; and
display the third image.

In a second aspect, the present disclosure provides a method comprising:
receiving, by at least one server from at least one client device, first pose information indicative of at least a pose of the at least one client device over a first time period;
estimating, at the at least one server, a first predicted pose corresponding to a future time instant, based on the first pose information;
generating, at the at least one server, a first image according to the first predicted pose;
receiving, at the at least one server from the at least one client device, second pose information indicative of at least the pose of the at least one client device over a second time period that ends after the first time period;
estimating, at the at least one server, a second predicted pose corresponding to the future time instant, based on the second pose information;
generating, at the at least one server, a second image by reprojecting the first image from the first predicted pose to the second predicted pose using a first reprojection algorithm;
sending the second image from the at least one server to the at least one client device;
collecting, at the at least one client device, third pose information indicative of at least the pose of the at least one client device over a third time period that ends after the second time period;
estimating, at the at least one client device, a third predicted pose corresponding to the future time instant, based on the third pose information;
generating, at the at least one client device, a third image by reprojecting the second image from the second predicted pose to the third predicted pose using a second reprojection algorithm; and displaying the third image at the at least one client device.

The present disclosure provides the aforementioned system and the aforementioned method for generating pose-consistent, high-quality, and realistic images in real time or near-real time (i.e., with minimal delay/latency). Instead of estimating a predicted pose of the at least one client device just once for the future time instant, the at least one server (remotely) estimates the first predicted pose and the second predicted pose based on pose information collected at different time periods (namely, the first time period and the second time period, which may partially overlap). Beneficially, in such a case, the second predicted pose is even more accurate and recent/up-to-date with respect to the future time instant, as compared to the first predicted pose. Moreover, the at least one server employs the first reprojection algorithm to perform a computationally-intensive reprojection (in a first round) for generating the second image (that is to be sent to the at least one client device). Beneficially, this potentially reduces a computational burden due to a subsequent reprojection (in a second round) at the at least one client device, thereby enabling the at least one client device to employ the second reprojection algorithm for generating the third image in a computationally-efficient and a time-efficient manner. In this manner, pose-consistent, high-quality third images are generated for displaying at the at least one client device, even when delay (for example, due to communication network traffic, transmission, compression-related overheads, and the like) are present between the at least one server and the at least one client device. Thus, the system and the method facilitates in minimizing motion-to-photons latency and stuttering, when displaying the third image at the at least one client device. Resultantly, this leads to an optimal (i.e., highly realistic), immersive viewing experience for a user of the at least one client device, when the third image is displayed to said user. The system and the method are simple, robust, support real-time and reliable multi-stage reprojection for remote extended-reality rendering, and can be implemented with ease.

Notably, the at least one server controls an overall operation of the system. In some implementations, the at least one server is implemented as a remote server. In an example, the remote server could be a cloud server that provides a cloud computing service, and could be arranged in a geographical location that is different from a geographical location of the at least one client device. In other implementations, the at least one server is implemented as a processor of a computing device that is communicably coupled to the at least one client device. Examples of the computing device include, but are not limited to, a laptop, a desktop, a tablet, a phablet, a personal digital assistant, a workstation, and a console. Optionally, the system further comprises the at least one client device.

The at least one client device could be implemented as a display device, or as another device serving the display device. Examples of the display device include, but are not limited to, a head-mounted display (HMD) device, and a smartphone. As an example, a smartphone can be inserted into a viewer made from cardboard, to display images to the user. The term “head-mounted display” device refers to a specialized equipment that is configured to present an extended-reality (XR) environment to a user when said HMD device, in operation, is worn by a user on his/her head. The HMD device is implemented, for example, as an XR headset, a pair of XR glasses, and the like, that is operable to display a scene of the XR environment to the user. The term “extended-reality” encompasses virtual reality (VR), augmented reality (AR), mixed reality (MR), and the like.

It will be appreciated that the term “at least one server” refers to “a single server” in some implementations, and to “a plurality of servers” in other implementations. When the system comprises the single server, all operations of the system can be performed by the single server. When the system comprises the plurality of servers, different operations of the system can be performed by different (and specially configured) servers from amongst the plurality of servers. As an example, a first server from amongst the plurality of servers may be configured to estimate the first predicted pose, based on the first pose information, and a second server from amongst the plurality of servers may be configured to estimate the second predicted pose, based on the second pose information.

Throughout the present disclosure, the term “pose” encompasses both a viewing position and a viewing direction of the at least one client device that is present in a real-world environment. It will be appreciated that the at least one server receives the first pose information from the at least one client device in real time or near-real time (i.e., without any latency/delay). It will also be appreciated that the pose of the at least one client device may not necessarily be same during an entirety of a given time period, and may change at different time instants during the given time period. In such a case, given pose information would be indicative of different poses of the at least one client device corresponding to the different time instants during the given time period. The term “given pose information” encompasses the first pose information and the second pose information. The term “given time period” encompasses the first time period and the second time period.

Optionally, the at least one client device comprises tracking means for tracking at least the pose of the at least one client device. In this regard, given pose information is collected by the tracking means of the at least one client device. Apart from tracking the pose, the tracking means may also be employed to track a velocity and/or an acceleration with which the pose changes. In such a case, the given pose information may also be indicative of the velocity and/or the acceleration with which the pose changes.

It will be appreciated that the tracking means could be implemented as at least one of: an optics-based tracking system (which utilizes, for example, infrared beacons and detectors, IR cameras, visible-light cameras, detectable objects and detectors, and the like), an acoustics-based tracking system, a radio-based tracking system, a magnetism-based tracking system, an accelerometer, a gyroscope, an Inertial Measurement Unit (IMU), a Timing and Inertial Measurement Unit (TIMU). As an example, a detectable object may be an active infra-red (IR) LED, a visible LED, a laser illuminator, a Quick Response (QR) code, an ArUco marker, an anchor marker, a Radio Frequency Identification (RFID) marker, and the like. A detector may be implemented as at least one of: an IR camera, an IR transceiver, a visible-light camera, an RFID reader. Optionally, the tracking means is implemented as a true six degrees-of-freedom (6DoF) tracking system. The tracking means may employ an outside-in tracking technique, an inside-out tracking technique, or a combination of both the aforesaid techniques, for collecting the given pose information that is indicative of at least the pose of the at least one client device. It will be appreciated that the given pose information may be collected by the tracking means, i.e., continuously, periodically (for example, after every 10 milliseconds), or intermittently (for example, after 10 milliseconds, and then again after 50 milliseconds, and so on). For example, a rate of collecting the given pose information may be high, when a user of the at least one client device is moving in the real-world environment. In such a case, the given pose information may, for example, be collected at every millisecond.

Optionally, the given pose information is collected by the tracking means in a global coordinate space. Herein, the term “global coordinate space” refers to a 3D space of the real-world environment that is represented by a global coordinate system. The global coordinate system could, for example, such as a Cartesian coordinate system having a predefined origin and three mutually perpendicular coordinate axes namely, X, Y, and Z axes. A viewing position in the global coordinate system may be expressed as (x, y, z) position coordinates along the X, Y and Z axes, respectively. Optionally, the given pose information is further indicative of at least one of: a linear velocity, a linear acceleration, an angular velocity, an angular acceleration, with which the pose of the at least one client device changes over a given time period.

It will be appreciated that since the first pose information is indicative of the different poses of the at least one client device corresponding to the different time instants during the first time period, the at least one server can easily and accurately estimate the first predicted pose, for example, by projecting/extrapolating a trend of the different poses of the at least one client device. Throughout the present disclosure, the term “predicted pose” refers to an expected pose (i.e., a future pose) of the at least one client device at the future time instant. The term “future time instant” refers to a time instant at which the third image is expected to be displayed at the at least one client device. It will be appreciated that the future time instant could be different from an actual time instant at which the third image is actually displayed at the at least one client device.

Optionally, when estimating a given predicted pose, the at least one server is configured to process the given pose information using at least one data processing algorithm. The at least one data processing algorithm include, but are not limited to, a feature detection algorithm, and a data extrapolation algorithm. The aforesaid data processing algorithms are well-known in the art. It will be appreciated that the given pose information may be in form of images, IMU/TIMU values, motion sensor data values, magnetic field strength values, or similar. The term “given predicted pose” encompasses at least the first predicted pose and the second predicted pose.

Notably, the first image is generated according to a (predicted) viewing position and a (predicted) viewing direction of the at least one client device as indicated by the first predicted pose. In some implementations, the first image may be a visual representation of an extended-reality environment from a perspective of the first predicted pose of the at least one client device, wherein said visual representation is generated by the at least one server, for example, using a three-dimensional (3D) model of the extended-reality environment (as discussed hereinbelow). In other implementations, the first image may represent at least one virtual object that is to be embedded on a video-see-through (VST) image captured by at least one camera of the at least one client device, for subsequently generating an MR image. In such a case, the at least one virtual object is generated according to the first predicted pose. In this regard, the at least one server is configured to employ at least a virtual object generation algorithm. The term “virtual object” refers to a computer-generated object (namely, a digital object). Examples of the at least one virtual object may include, but are not limited to, a virtual navigation tool (such as a virtual map), a virtual gadget, a virtual entity (such as a virtual person, a virtual animal, a virtual ghost, and the like), and a virtual vehicle or part thereof (such as a virtual car, a virtual cockpit, and so forth).

The term “visual representation” encompasses colour information represented in the given image, and additionally optionally other attributes associated with the given image (for example, such as depth information, luminance information, transparency information, and the like). Optionally, the colour information represented in the given image is in form of at least one of: Red-Green-Blue (RGB) values, Red-Green-Blue-Alpha (RGB-A) values, Cyan-Magenta-Yellow-Black (CMYK) values, Luminance and two-colour differences (YUV) values, Red-Green-Blue-Depth (RGB-D) values, Hue-Chroma-Luminance (HCL) values, Hue-Saturation-Lightness (HSL) values, Hue-Saturation-Brightness (HSB) values, Hue-Saturation-Value (HSV) values, Hue-Saturation-Intensity (HSI) values, blue-difference and red-difference chroma components (YCbCr) values.

Optionally, the at least one server is configured to obtain the 3D model from at least one data repository that is communicably coupled to the at least one server. In such a case, the 3D model is pre-generated (for example, by the at least one server), and pre-stored at the at least one data repository. It will be appreciated that the at least one data repository could be implemented, for example, such as a memory of the at least one server, a memory of the computing device, a memory of the at least one client device, a removable memory, a cloud-based database, or similar. Optionally, the system further comprises the at least one data repository.

The term “three-dimensional model” of the extended-reality environment refers to a data structure that comprises comprehensive information pertaining to objects or their parts present in the extended-reality environment. Such comprehensive information is indicative of at least one of: surfaces of the objects or their parts, a plurality of features of the objects or their parts, shapes and sizes of the objects or their parts, poses of the objects or their parts, materials of the objects or their parts, colour information of the objects or their parts, depth information of the objects or their parts, light sources and lighting conditions within the extended-reality environment. The term “object” refers to a physical object or a part of the physical object that is present in the extended-reality environment. An object could be a living object (for example, such as a human, a pet, a plant, and the like) or a non-living object (for example, such as a wall, a building, a shop, a road, a window, a toy, a poster, a lamp, and the like). Examples of the plurality of features include, but are not limited to, edges, corners, blobs, a high-frequency feature, a low-frequency feature, and ridges.

Optionally, the 3D model of the extended-reality environment is in a form of at least one of: a 3D polygonal mesh, a 3D point cloud, a 3D surface cloud, a 3D surflet cloud, a voxel-based model, a parametric model, a 3D grid, a 3D hierarchical grid, a bounding volume hierarchy, an image-based 3D model. The 3D polygonal mesh could be a 3D triangular mesh or a 3D quadrilateral mesh. The aforesaid forms of the 3D model are well-known in the art.

Optionally, when generating the first image, the at least one server is configured to utilise the 3D model. Optionally, in this regard, the at least one server is configured to employ at least one data processing algorithm. The at least one data processing algorithm would enable in transforming a 3D point in the 3D model to a 2D point in the first image, from the perspective of the first predicted pose of the at least one client device. Optionally, the at least one data processing algorithm is at least one of: an image synthesis algorithm (such as an RGB-D image synthesis algorithm), a view synthesis algorithm, a rendering algorithm. Such data processing algorithms are well-known in the art. In an example, when the 3D model is in the form of a 3D polygonal mesh (for example, such as a 3D triangular mesh), the image synthesis algorithm may be a triangle rasterization algorithm. In another example, when the 3D model is in the form of a voxel-based model (such as a Truncated Signed Distance Field (TSDF) model), the image synthesis algorithm may be a ray-marching algorithm. In yet another example, when the 3D model is in the form of a 3D point cloud, the rendering algorithm may be a point cloud rendering algorithm, a point cloud splatting algorithm, an elliptical weighted-average surface splatting algorithm, or similar.

Optionally, prior to utilising the 3D model, the at least one server is configured to generate the 3D model from a plurality of visible-light images and a plurality of depth images (corresponding to the plurality of visible-light images), based on corresponding poses from perspectives of which the plurality of visible-light images and the plurality of depth images are captured. Optionally, in this regard, the at least one server is configured to employ at least one data processing algorithm for processing the plurality of visible-light images and the plurality of depth images to generate the 3D model. Optionally, the at least one data processing algorithm comprises at least one of: a feature extraction algorithm, an image stitching algorithm, an image merging algorithm, an interpolation algorithm, a 3D modelling algorithm, a photogrammetry algorithm, an image blending algorithm. Such data processing algorithms are well-known in the art. Beneficially, the 3D model generated in this manner would be very accurate (for example, in terms of generating the first image using the 3D model), highly realistic, and information-rich. The 3D model could be generated prior to a given session of using the at least one client device. Optionally, the 3D model is generated in the global coordinate space.

It will be appreciated that the plurality of visible-light images, the plurality of depth images, and information pertaining to the corresponding poses could be received by the at least one server from any of:
the at least one client device comprising the tracking means and at least one camera that is implemented as a combination of a visible-light camera and a depth camera, or
at least one data repository in which the plurality of colour images, the plurality of depth maps, and said information are pre-stored.

Notably, upon generating the first image, the at least one server receives the second pose information. The second time period (during which the second pose information is collected by the tracking means) may or may not partially overlap with the first time period. However, since the second time period ends after the first time period, the second pose information is indicative of more recent/latest poses of the at least one client device, as compared to the first pose information. Therefore, it is highly likely that the second predicted pose is significantly more accurate and more precise than the first predicted pose. In other words, the second predicted pose may be understood to be a rectified version (namely, a fine-tuned or an up-to-date version) of the first predicted pose of the at least one client device with respect to the future time instant. It is to be understood that the second time period ends after the first time period but earlier than the future time instant. It will be appreciated that the at least one server receives the second pose information from the at least one client device in real time or near-real time. Estimation of the second predicted pose is performed by the at least one server in a similar manner as discussed earlier with respect to the first predicted pose.

Furthermore, since the second predicted pose is more accurate and up-to-date than the first predicted pose with respect to the future time instant, the at least one server is configured to generate the second image by reprojecting the first image to match the perspective of the second predicted pose, according to a difference between the first predicted pose and the second predicted pose. Optionally, the second image is a visual representation of the extended-reality environment from a perspective of the second predicted pose of the at least one client device, wherein said visual representation is generated by reprojecting the first image in the aforesaid manner.

Upon generating the second image, the at least one server sends the second image to the at least one client device in real time or near-real time (i.e., without any latency/delay). The at least one client device utilises the second image to generate the third image that is to be subsequently displayed thereat, as discussed later. Optionally, the at least one server is configured to send the second image along with a depth map corresponding to the second image, wherein the depth map is utilized at the at least one client device when generating the third image by using the second reprojection algorithm.

Notably, upon receiving the second image, the third pose information is collected by the at least one client device. The third time period (during which the third pose information is collected by the tracking means) may or may not partially overlap with the second time period. However, since the third time period ends after the second time period, the third pose information is indicative of even more recent/latest poses of the at least one client device, as compared to the second pose information.

Therefore, it is highly likely that the third predicted pose is even more significantly accurate and precise than the second predicted pose. In other words, the third predicted pose may be understood to be a rectified version of the second predicted pose of the at least one client device. It is to be understood that the third time period ends after the second time period but still earlier than the future time instant. It will be appreciated that the at least one client device collects the third pose information in real time or near-real time. Estimation of the third predicted pose is performed by (a processor of) the at least one client device in a similar manner as discussed earlier with respect to the first predicted pose (that is estimated by the at least one server).

Further, since the third predicted pose is more accurate and up-to-date than the second predicted pose with respect to the future time instant, the at least one client device is configured to generate the third image by reprojecting the second image to match the perspective of the third predicted pose, according to a difference between the second predicted pose and the third predicted pose. In some implementations, the third image is a visual representation of the extended-reality environment from a perspective of the third predicted pose of the at least one client device, wherein said visual representation is generated by reprojecting the second image in aforesaid manner. In other implementations, namely in a case of generating the MR image as discussed earlier, the at least one virtual object is reprojected from the first predicted pose to the second predicted pose, prior to sending to the at least one client device as the second image; at the at least one client device, the at least one virtual object is again reprojected from the second predicted pose to the third predicted pose, and then the at least one virtual object is digitally embedded on the VST image, for generating the MR image.

It will be appreciated that the first reprojection algorithm and the second reprojecting algorithm may comprise at least one space warping algorithm, and may perform any of: a three degrees-of-freedom (3DOF) reprojection, a six degrees-of-freedom (6DOF) reprojection, a nine degrees-of-freedom (9DOF) reprojection. The “3DOF reprojection” is an image reprojection that is performed by taking into account only differences between viewing directions of the at least one client device, without taking into consideration any changes in viewing positions of the at least one client device. Such an approach is relatively fast and simple as it involves a straightforward texture lookup without any need for complex searching or marching algorithms. The “6DOF reprojection” is an image reprojection that is performed by taking into account both changes in the viewing directions and changes in the viewing positions of the at least one client device. In addition to this, the 6DOF reprojection utilises depth information (for example, in form of depth maps) and ray marching/iterative image warping approaches, and requires multiple texture lookups per pixel. The “9DOF reprojection” is an image reprojection that is performed by taking into account changes in the viewing directions of the at least one client device, changes in the viewing positions of the at least one client device, and a motion of rendered content. Such an approach requires per-pixel motion vectors (namely, optical flow vectors of moving objects), motion estimator blocks from various video encoders, or similar. It is to be understood that the 6DOF reprojection and the 9DOF reprojection are relatively more accurate, but are slightly computationally intensive as compared to the 3DOF reprojection. Reprojection algorithms and the three aforesaid reprojections are well-known in the art.

In an embodiment, the second reprojection algorithm is different from the first reprojection algorithm. In this regard, the at least one server may be configured to employ the first reprojection algorithm to perform a computationally-intensive reprojection (in a first round) for generating the second image (that is to be sent to the at least one client device). Beneficially, this potentially reduces a computational burden due to a subsequent reprojection (in a second round) at the at least one client device, thereby facilitating the at least one client device to employ the second reprojection algorithm for generating the third image in a computationally-efficient and a time-efficient manner. Optionally, in such a case, the first reprojection algorithm performs any of: the 6DOF reprojection, the 9DOF reprojection, while the second reprojection algorithm performs the 3DOF reprojection. In another embodiment, the second reprojection algorithm is same as the first reprojection algorithm. As an example, the first reprojection algorithm and the second reprojection algorithm perform the 9DOF reprojection.

Notably, upon generating the third image, (the processor of) the at least one client device is configured to display the third image, for example, via at least one light source of the at least one client device. The term “light source” refers to an element from which light emanates. Optionally, the at least one light source is implemented as a display or a projector. Displays and projectors are well-known in the art. The at least one light source may be a single-resolution light source or a multi-resolution light source. It will be appreciated that the third image is displayed at the at least one client device at the future time instant, or at another refined/corrected time instant (that could be sooner or later than the future time instant).

Furthermore, optionally, the at least one server is configured to:
generate a motion vector map corresponding to the second image, based on previously-generated second images, using at least one optical flow algorithm, wherein the motion vector map indicates motion vectors per pixel or per group of pixels; and
send the motion vector map to the at least one client device, wherein the at least one client device is configured to utilize the motion vector map with the second reprojection algorithm, to perform a nine degrees-of-freedom (9DOF) reprojection.

In this regard, since the 9DOF reprojection is performed by taking into account movement of objects or their portions in the extended-reality environment (as discussed earlier), the motion vector map is generated by the at least one server to enable the at least one client device to accurately and conveniently perform the 9DOF reprojection, in a computationally-efficient and a time-efficient manner.

The motion vector map includes motion vectors for each pixel or each group of pixels in the second image. Such a motion vector for a given pixel or a given group of pixels is calculated with respect to a corresponding pixel or a corresponding group of pixels in a previous second image that was generated previously for a previous time instant before the future time instant. In other words, the motion vector map represents comprehensive information pertaining to overall motion patterns/movements of the objects or their portions represented in the second image. When a pixel represents a stationary object or a stationary portion of an object, a motion vector of said pixel is zero. On the other hand, when a pixel represents a moving (i.e., dynamic) object or a moving portion of an object, a motion vector of said pixel is non-zero. In some cases, the object may not be moving, however, the pose of the at least one client device may be changing. In such cases, the motion vector of pixels representing the object may be non-zero. Determining motion vectors of pixels or groups of pixels and generating the motion vector map using the at least one optical flow algorithm are well-known in the art.

It will be appreciated that a motion vector is indicative of a speed and a direction of a movement of an object or a moving portion of the object, between two images (namely, the second image and the previous second image). In other words, the motion vector indicates a motion with which a pixel or a given group of pixels is moving from one frame to another frame. This motion is expressed in terms of a magnitude of displacement of a pixel per unit time, and a direction of the displacement. As an example, an object may move in a horizontal direction, so a magnitude of the motion vector of a pixel representing the object may be 2 pixels per millisecond, and a direction of the motion vector may be the horizontal direction. As another example, an object may move in a vertical direction, so a magnitude of the motion vector of a pixel representing the object may be 8 pixels per millisecond, and a direction of the motion vector may be the vertical direction. As yet another example, an object may move in a diagonal direction, so a magnitude of the motion vector of a pixel representing the object may be 3 pixels per millisecond, and a direction of the motion vector may be the diagonal direction. It will also be appreciated that generating the motion vector map by determining the motion vectors per group of pixels (for example, groups of 2×2 pixels, 3×3 pixels, 2×3 pixels, or similar) is considerably faster as compared to when motion vectors are to be determined in a pixel-by-pixel manner. Moreover, when such a motion vector map is utilized by the at least one client device, the 9DOF reprojection can still be performed acceptably accurately.

It is to be understood that the motion vector map could be utilised at the at least one client device even when the first reprojecting algorithm and the second reprojecting algorithm are different (for example, when the at least one server performs the 6DOF reprojection, while the at least one client device performs the 9DOF reprojection), or even when the first reprojecting algorithm and the second reprojecting algorithm are same (for example, when both the at least one server and the at least one client device performs the 9DOF reprojection). It will be appreciated that the motion vector map is sent to the at least one client device along with the second image, in real time or near-real time. Optionally, when utilizing the motion vector map with the second reprojection algorithm, the at least one client device can easily estimate, from the motion vector map, a displacement (and a direction of said displacement) of a given pixel or a group of pixels representing a given object (that is to be represented in the third image) when reprojecting the second image from the second predicted pose to the third predicted pose. In this manner, the third image is highly accurately generated.

Moreover, optionally, the at least one server is configured to:
generate a cone angle map based on a depth map corresponding to the second image, wherein the cone angle map indicates cone angles per texel or per group of texels of the depth map, wherein a given cone angle for a given texel or a given group of texels indicates an angle of an imaginary cone whose apex is at the given texel or the given group of texels and within which a given viewing ray can intersect with at most one surface during ray marching; and
send the cone angle map to the at least one client device, wherein the at least one client device is configured to utilize the cone angle map with the second reprojection algorithm, to perform ray marching for any of: a six degrees-of-freedom (6DOF) reprojection, a nine degrees-of-freedom (9DOF) reprojection.

In this regard, the cone angle map is generated by the at least one server to enable the at least one client device to accurately and conveniently perform the ray marching for the 6DOF reprojection or the 9DOF reprojection, in a computationally-efficient and a time-efficient manner. This is made possible by sending the cone angle map, instead of the depth map, which allows for reduced requirement for network transmission bandwidth and for processing at the at least one client device.

The term “depth map” refers to a data structure comprising information pertaining to optical depths of the objects (or their portions) represented in the second image. It will be appreciated that the depth map corresponding to the second image could be easily generated using the 3D model, as information pertaining to the optical depths is accurately known from the 3D model in detail from the perspective of the second predicted pose of the at least one client device. Thus, the depth map would be indicative of placements, textures, geometries, occlusions, and the like, of the objects or their parts from the perspective of the second predicted pose. In such a case, texels (namely, pixels representing textures of surfaces of the objects or their parts) of the depth map can be accurately and easily determined.

It will be appreciated that for the given group of texels (for example, groups of 2×2 texels, 3×3 texels, 2×3 texels, or similar), the imaginary cone may be assigned to the given group of texels, such that the apex of the imaginary cone lies, for example, at a midpoint of the given group of texels. The imaginary cone could be represented by its width-to-height ratio. Both the depth map and the cone angle map could be stored at the at least one data repository using a single luminance-alpha texture. Alternatively, the cone angle map could be stored in a colour channel of a relief texture.

It will also be appreciated that a radius of the imaginary cone could be made considerably larger such that when the cone angle map is utilised for the ray marching, the given viewing ray can intersect with (i.e., pierce through) a surface of an object represented in the second image in fewer steps of space leaping. Beneficially, in such a case, optical depths of pixels corresponding to the object can be highly accurately determined from a perspective of the given viewing ray. Moreover, the cone angle map indicating such wider/relaxed imaginary cones facilitates in performing said ray marching in a computationally-efficient and time-efficient manner. This is due to the fact that space leaping for the given viewing ray can be accelerated, i.e., the given viewing ray would have to traverse through a lesser number of such imaginary cones for finding the intersection with the at most one surface, as compared to when imaginary cones having relatively smaller radii are indicated in the cone angle map. Furthermore, such wider/relaxed imaginary cones eliminate a need to employ a linear search for estimating the optical depths (and thus prevent generation of artifacts associated with such a linear search). Since the given viewing ray pierces the at most one surface once, it would be simple and reliable to employ a binary search for refinement of the optical depths.

Further, the cone angle map is sent to the at least one client device along with the second image, in real time or near-real time. Optionally, when utilizing the cone angle map, the at least one client device can easily and efficiently perform the ray marching in order to estimate the optical depths of the pixels corresponding to the object from the perspective of the given viewing ray. Then, the at least one client device can perform any of: the 6DOF reprojection, the 9DOF reprojection, based on said optical depths, using the second reprojection algorithm. In this manner, the third image is highly accurately generated. The ray marching is well-known in the art. One such way of generating the cone angle map and utilising it for ray marching is well described, for example, in “Relaxed Cone Stepping for Relief Mapping” by F. Policarpo and Manuel M. Oliveira, published in GPU Gems 3, pp. 409-428, 2007, which has been incorporated herein by reference.

Furthermore, optionally, the at least one server is configured to:
generate an acceleration structure based on at least a depth map corresponding to the second image; and
send the acceleration structure to the at least one client device, wherein the at least one client device is configured to utilize the acceleration structure with the second reprojection algorithm.

It will be appreciated that the acceleration structure is sent, instead of the depth map, which allows for reduced requirement for network transmission bandwidth and for processing at the at least one client device. Herein, the term “acceleration structure” refers to a data structure comprising at least geometric information of objects or their parts represented in a given image. Examples of the acceleration structure include, but are not limited to, a polygonal mesh, a point cloud, a surface cloud, a surflet cloud, a 3D grid, a 3D hierarchical grid, a bounding volume hierarchy. The aforesaid acceleration structures are well-known in the art. Optionally, when generating the acceleration structure, the at least one server is configured to employ a depth map-based reconstruction technique. Such a depth map-based reconstruction technique facilitates in transforming the depth information of the depth map into a data structure representing the geometric information of the objects or their parts represented in the second image. Upon said generation, the acceleration structure is sent to the at least one client device along with the second image, in real time or near-real time. Pursuant to the present disclosure, the acceleration structure enables the at least one client device to accelerate a process of reprojecting the second image from the second predicted pose to the third predicted pose, to generate the third image. This may be because taking into account the geometric information enables the at least one client device to utilise accurate depth information, feature matching, and reliable spatial transformations necessary for the aforesaid reprojection. In this way, the third image is highly accurately generated in a computationally-efficient and time-efficient manner.

Moreover, optionally, the at least one server is configured to:
estimate the future time instant as a time instant at which the third image is expected to be displayed at the at least one client device, based on at least one of: a time period elapsed between display of consecutive images at the at least one client device, time at which a previous third image was displayed at the at least one client device; and
refine the future time instant prior to estimating the second predicted pose, based on a change in the time at which the previous third image was displayed.

In this regard, by the time when the at least one server has to estimate the second predicted pose, the future time instant (that was estimated earlier) may have changed, and thus it needs to be refined (namely, updated) accordingly. For example, prior to estimating the second predicted pose (at a server side), the future time instant may change from T1 to T2, wherein T2 may or may not be different from T1. Moreover, prior to estimating the third predicted pose (at a client side), the future time instant may again change from T2 to T3, wherein T3 may or may not be different from T2. In addition to this, the third image may be displayed at the at least one client device at an actual time instant T4, which may or may not be different from T3. It will be appreciated that the time period elapsed between display of the consecutive images at the at least one client device can be easily known from a framerate (for example, in terms of frames per second (FPS)) of displaying the consecutive images at the at least one client device. For example, when the framerate is 100 FPS, the time period elapsed between display of the consecutive images would be 10 milliseconds. Moreover, information pertaining to the time at which the previous third image was displayed could be received by the at least one server from the at least one client device itself. Thus, the future time instant can be easily estimated by the at least one server. However, the estimated future time instant need to be refined because a clock at the at least one server may not be synchronized with a local clock at the at least one client device, and there are often delays (for example, due to communication network traffic, processing delays, compression-related overheads, and the like) between the at least one server and the at least one client device. In this regard, the future time instant is refined according to the change in the time at which the previous third image was displayed. It will be appreciated that the change in the time could be determined, for example, by implementing at least one of: a network time protocol (NTP), a precision time protocol (PTP) between the at least one server and the at least one client device. Implementation of the aforesaid protocols is well-known in the art.

Optionally, the at least one client device is configured to refine the future time instant prior to estimating the third predicted pose, based on at least one of: a time period elapsed between display of consecutive images at the at least one client device, actual time at which a previous third image was displayed at the at least one client device. In this regard, by the time when the at least one client device has to estimate the third predicted pose, the future time instant (that was estimated earlier) may have changed, and thus it need to be refined accordingly. As described earlier, the time period elapsed between display of the consecutive images can be known from the framerate. Moreover, information pertaining to the actual time at which the previous third image was displayed could be accurately known to the at least one client device, according to the local clock at the at least one client device. Thus, the future time instant can be easily refined by the at least one client device as the at least one client device can now determine an actual time at which a subsequent/future third image would be displayed at the at least one client device.

The present disclosure also relates to the method as described above. Various embodiments and variants disclosed above, with respect to the aforementioned system apply mutatis mutandis to the method.

Optionally, the method further comprises:
generating, at the at least one server, a motion vector map corresponding to the second image, based on previously-generated second images, using at least one optical flow algorithm, wherein the motion vector map indicates motion vectors per pixel or per group of pixels;
sending the motion vector map from the at least one server to the at least one client device; and
utilizing, at the at least one client device, the motion vector map with the second reprojection algorithm, to perform a nine degrees-of-freedom (9DOF) reprojection.

Optionally, the method further comprises:
generating, at the at least one server, a cone angle map based on a depth map corresponding to the second image, wherein the cone angle map indicates cone angles per texel or per group of texels of the depth map, wherein a given cone angle for a given texel or a given group of texels indicates an angle of an imaginary cone whose apex is at the given texel or the given group of texels and within which a given viewing ray can intersect with at most one surface during ray marching;
sending the cone angle map from the at least one server to the at least one client device; and
utilizing, at the at least one client device, the cone angle map with the second reprojection algorithm, to perform ray marching for any of: a six degrees-of-freedom (6DOF) reprojection, a nine degrees-of-freedom (9DOF) reprojection.

Optionally, the method further comprises:
generating, by the at least one server, an acceleration structure based on at least a depth map corresponding to the second image;
sending the acceleration structure from the at least one server to the at least one client device; and
utilizing, at the at least one client device, the acceleration structure with the second reprojection algorithm.

Optionally, the method further comprises:
estimating, at the at least one server, the future time instant as a time instant at which the third image is expected to be displayed at the at least one client device, based on at least one of: a time period elapsed between display of consecutive images at the at least one client device, time at which a previous third image was displayed at the at least one client device; and
refining, at the at least one server, the future time instant prior to estimating the second predicted pose, based on a change in the time at which the previous third image was displayed.

Optionally, the method further comprises refining, at the at least one client device, the future time instant prior to estimating the third predicted pose, based on at least one of: a time period elapsed between display of consecutive images at the at least one client device, actual time at which a previous third image was displayed at the at least one client device.

### DETAILED DESCRIPTION OF THE DRAWINGS

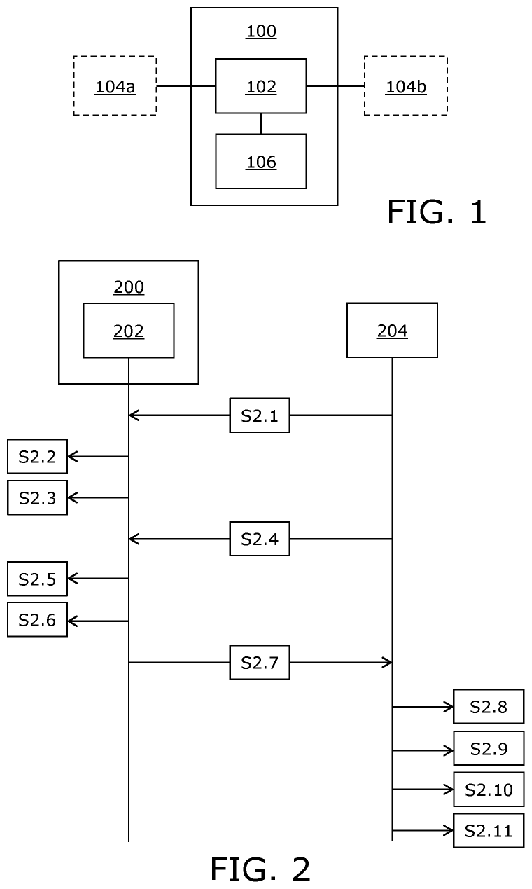

Referring to FIG. 1, illustrated is a block diagram of an architecture of a system 100 incorporating multi-stage reprojection for server-based extended-reality (XR) rendering, in accordance with an embodiment of the present disclosure. The system 100 comprises at least one server (depicted as a server 102). The server 102 is communicably coupled to at least one client device (depicted as client devices 104a and 104b). Optionally, the system 100 further comprises at least one data repository (depicted as a data repository 106).

It may be understood by a person skilled in the art that the FIG. 1 includes a simplified architecture of the system 100 for sake of clarity, which should not unduly limit the scope of the claims herein. It is to be understood that a specific implementation of the system 100 is provided as an example and is not to be construed as limiting it to specific numbers or specific types of servers, client devices, and data repositories. The person skilled in the art will recognize many variations, alternatives, and modifications of embodiments of the present disclosure.

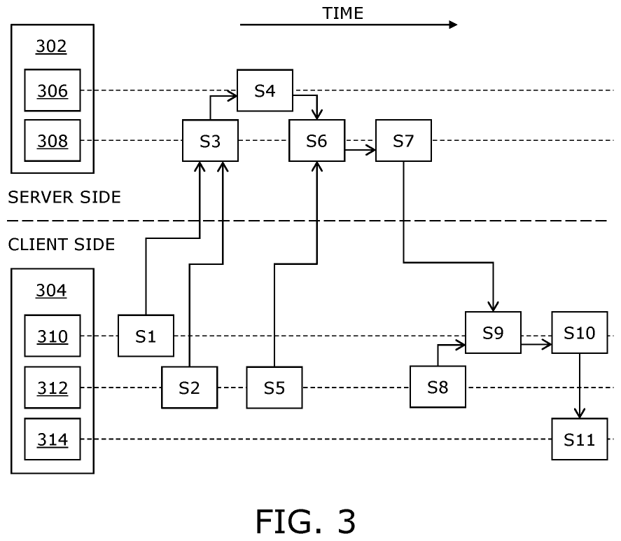

Referring to FIG. 2, illustrated is a sequence diagram showing operational steps of a system 200 incorporating multi-stage reprojection for server-based XR rendering, in accordance with an embodiment of the present disclosure. The system 200 comprises at least one server (depicted as a server 202) that is communicably coupled to at least one client device (depicted as a client device 204). At step S2.1, first pose information is received at the server 202 from the client device 204, the first pose information being indicative of at least a pose of the client device 204 over a first time period. At step S2.2, a first predicted pose corresponding to a future time instant is estimated at the server 202, based on the first pose information. At step S2.3, a first image is generated at the server 202 according to the first predicted pose. At step S2.4, second pose information is received at the server 202 from the client device 204, the second pose information being indicative of at least the pose of the client device 204 over a second time period that ends after the first time period. At step S2.5, a second predicted pose corresponding to the future time instant is estimated at the server 202, based on the second pose information. At step S2.6, a second image is generated at the server 202, by reprojecting the first image from the first predicted pose to the second predicted pose using a first reprojection algorithm. At step S2.7, the second image is sent from the server 202 to the client device 204. At step S2.8, third pose information is collected at the client device 204, the third pose information being indicative of at least the pose of the client device 204 over a third time period that ends after the second time period. At step S2.9, a third predicted pose corresponding to the future time instant is estimated at the client device 204, based on the third pose information. At step S2.10, a third image is generated at the client device 204, by reprojecting the second image from the second predicted pose to the third predicted pose using a second reprojection algorithm. At step S2.11, the third image is displayed at the client device 204.

Referring to FIG. 3, illustrated is a sequence diagram showing operational steps of a system incorporating multi-stage reprojection for server-based XR rendering, in accordance with another embodiment of the present disclosure. The system comprises at least one server (depicted as a server 302) that is communicably coupled to at least one client device (depicted as a client device 304). An XR application 306 and a server-side compositor 308 execute on the server 302. A client-side compositor 310 executes on the client device 304. The client device 304 is shown to comprise pose-tracking means 312 and at least one light source (depicted as a light source 314). At step S1, information pertaining to a time at which a previous third image was displayed at the client device 304, is sent from the client-side compositor 310 to the server-side compositor 308. At step S2, first pose information is sent from the pose-tracking means 312 to the server-side compositor 308, the first pose information being indicative of at least a pose of the client device 304 over a first time period. At step S3, a first predicted pose corresponding to a future time instant is estimated at the server-side compositor 308, along with a time instant at which a third image is expected to be displayed at the light source 314. At step S4, a first image is generated by the XR application 306 according to the first predicted pose. At step S5, second pose information is received from the pose-tracking means 312 to the server-side compositor 308, the second pose information being indicative of at least the pose of the client device 304 over a second time period that ends after the first time period. At step S6, a second predicted pose corresponding to the future time instant is estimated at the server-side compositor 308. At step S7, a second image is generated at the server-side compositor 308, by reprojecting the first image from the first predicted pose to the second predicted pose using a first reprojection algorithm. At step S8, third pose information is collected by the pose-tracking means 312, the third pose information being indicative of at least the pose of the client device 304 over a third time period that ends after the second time period. At step S9, the second image is received at the client-side compositor 310 from the server-side compositor 308, and a third predicted pose corresponding to the future time instant is also estimated at the client-side compositor 310. At step S10, a third image is generated by the client-side compositor 310, by reprojecting the second image from the second predicted pose to the third predicted pose using a second reprojection algorithm. At step S11, the third image is displayed at the light source 314.

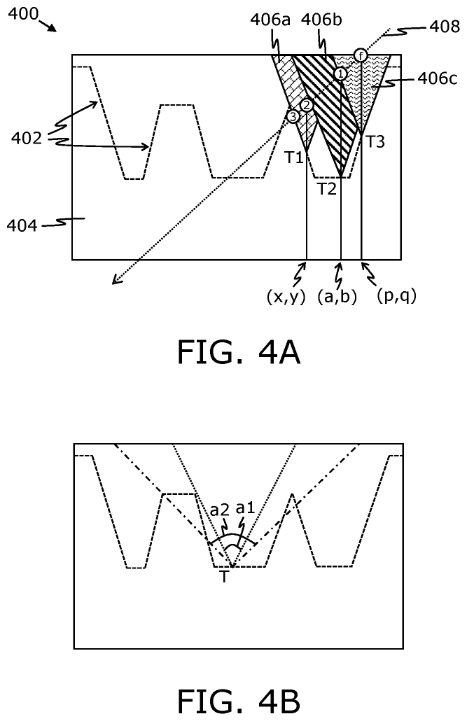

Referring to FIGS. 4A and 4B, FIG. 4A illustrates how a cone angle map 400 is utilized for performing ray marching, while FIG. 4B illustrates a comparison between a typical cone angle a1 and a relaxed cone angle a2 for a given texel T, in accordance with an embodiment of the present disclosure. With reference to FIGS. 4A and 4B, there is shown a part of the cone angle map 400 that is generated based on a depth map corresponding to a surface 402 (depicted using a dashed line) of an object 404. With reference to FIG. 4A, the cone angle map 400 indicates three imaginary cones 406a (depicted using a brick pattern), 406b (depicted using a diagonal line pattern), and 406c (depicted using a zig-zag pattern) having three different cone angles. Apices of the imaginary cones 406a-c are at texels T1, T2, and T3 that lie on the surface 402, respectively. During the ray marching, a viewing ray 408 (depicted using a dotted arrow) traverses through the imaginary cones 406a-c. The ray marching starts from a position ‘f’ along a direction of the viewing ray 408, for searching an intersection of the viewing ray 408 with the surface 402. Firstly, the viewing ray 408 intersects with the imaginary cone 406c stored at (p, q), for obtaining point ‘1’ having texture coordinates (a, b). Then, the viewing ray 408 further traverses through the imaginary cone 406b stored at (a, b), for obtaining point ‘2’ having texture coordinates (x, y). Next, the viewing ray 408 intersects with the imaginary cone 406a stored at (x y) for obtaining point ‘3’ at which the viewing ray 408 finally intersects with the surface 402.

With reference to FIG. 4B, the relaxed cone angle a2 of an imaginary cone (whose outline is depicted using a dash-dot line) is larger than the regular cone angle a1 of an imaginary cone (whose outline is depicted using a dotted line). When the cone angle map 400 indicates the imaginary cone having the relaxed cone angle a2, said cone angle map 400 facilitates in performing the ray marching (as discussed earlier with respect to FIG. 4A) in a computationally-efficient and time-efficient manner. This is because space leaping for the viewing ray 408 can be accelerated, i.e., the viewing ray 408 would have to traverse through a lesser number of such relaxed imaginary cones for finding the intersection of the viewing ray 408 with the surface 402, as compared to the imaginary cone having the regular (smaller) cone angle a1.

FIGS. 2, 3, 4A and 4B are merely examples, which should not unduly limit the scope of the claims herein. A person skilled in the art will recognize many variations, alternatives, and modifications of embodiments of the present disclosure.

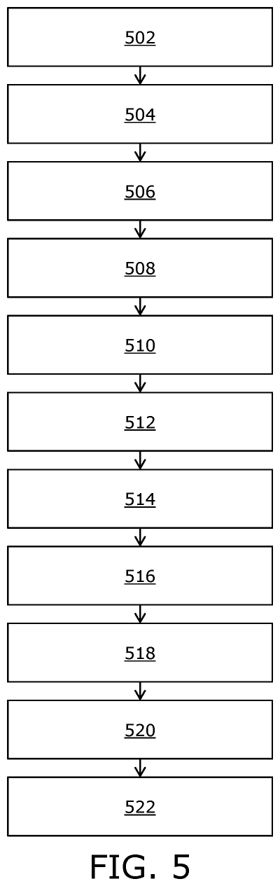

Referring to FIG. 5, illustrated are steps of a method incorporating multi-stage reprojection for server-based XR rendering, in accordance with an embodiment of the present disclosure. At step 502, first pose information is received by at least one server from the at least one client device, the first pose information being indicative of at least a pose of the at least one client device over a first time period. At step 504, a first predicted pose corresponding to a future time instant is estimated at the at least one server, based on the first pose information. At step 506, a first image is generated at the at least one server according to the first predicted pose. At step 508, second pose information is received at the at least one server from the at least one client device, the second pose information being indicative of at least the pose of the at least one client device over a second time period that ends after the first time period. At step 510, a second predicted pose corresponding to the future time instant is estimated at the at least one server, based on the second pose information. At step 512, a second image is generated at the at least one server, by reprojecting the first image from the first predicted pose to the second predicted pose using a first reprojection algorithm. At step 514, the second image is sent from the at least one server to the at least one client device. At step 516, third pose information is collected at the at least one client device, the third pose information being indicative of at least the pose of the at least one client device over a third time period that ends after the second time period. At step 518, a third predicted pose corresponding to the future time instant is estimated at the at least one client device, based on the third pose information. At step 520, a third image is generated at the at least one client device, by reprojecting the second image from the second predicted pose to the third predicted pose using a second reprojection algorithm. At step 522, the third image is displayed at the at least one client device.

The aforementioned steps are only illustrative and other alternatives can also be provided where one or more steps are added, one or more steps are removed, or one or more steps are provided in a different sequence without departing from the scope of the claims herein.

1. A system comprising at least one server that is communicably coupled to at least one client device, wherein the at least one server is configured to:
receive, from the at least one client device, first pose information indicative of at least a pose of the at least one client device over a first time period;
estimate a first predicted pose corresponding to a future time instant, based on the first pose information;
generate a first image according to the first predicted pose;
receive, from the at least one client device, second pose information indicative of at least the pose of the at least one client device over a second time period that ends after the first time period;
estimate a second predicted pose corresponding to the future time instant, based on the second pose information;
generate a second image by reprojecting the first image from the first predicted pose to the second predicted pose using a first reprojection algorithm; and
send the second image to the at least one client device,
wherein the at least one client device is configured to:
collect third pose information indicative of at least the pose of the at least one client device over a third time period that ends after the second time period;
estimate a third predicted pose corresponding to the future time instant, based on the third pose information;
generate a third image by reprojecting the second image from the second predicted pose to the third predicted pose using a second reprojection algorithm; and
display the third image.

2. The system of claim 1, wherein the second reprojection algorithm is different from the first reprojection algorithm.

3. The system of claim 1, wherein the second reprojection algorithm is same as the first reprojection algorithm.

4. The system of claim 1, wherein the at least one server is configured to:
generate a motion vector map corresponding to the second image, based on previously-generated second images, using at least one optical flow algorithm, wherein the motion vector map indicates motion vectors per pixel or per group of pixels; and
send the motion vector map to the at least one client device,
wherein the at least one client device is configured to utilize the motion vector map with the second reprojection algorithm, to perform a nine degrees-of-freedom (9DOF) reprojection.

5. The system of claim 1, wherein the at least one server is configured to:
generate a cone angle map based on a depth map corresponding to the second image, wherein the cone angle map indicates cone angles per texel or per group of texels of the depth map, wherein a given cone angle for a given texel or a given group of texels indicates an angle of an imaginary cone whose apex is at the given texel or the given group of texels and within which a given viewing ray can intersect with at most one surface during ray marching; and
send the cone angle map to the at least one client device,
wherein the at least one client device is configured to utilize the cone angle map with the second reprojection algorithm, to perform ray marching for any of: a six degrees-of-freedom (6DOF) reprojection, a nine degrees-of-freedom (9DOF) reprojection.

6. The system of claim 2, wherein the first reprojection algorithm performs any of: a six degrees-of-freedom (6DOF) reprojection, a nine degrees-of-freedom (9DOF) reprojection, while the second reprojection algorithm performs a three degrees-of-freedom (3DOF) reprojection.

7. The system of claim 1, wherein the at least one server is configured to:
generate an acceleration structure based on at least a depth map corresponding to the second image; and
send the acceleration structure to the at least one client device,
wherein the at least one client device is configured to utilize the acceleration structure with the second reprojection algorithm.

8. The system of claim 1, wherein the at least one server is configured to:
estimate the future time instant as a time instant at which the third image is expected to be displayed at the at least one client device, based on at least one of: a time period elapsed between display of consecutive images at the at least one client device, time at which a previous third image was displayed at the at least one client device; and
refine the future time instant prior to estimating the second predicted pose, based on a change in the time at which the previous third image was displayed.

9. The system of claim 1, wherein the at least one client device is configured to refine the future time instant prior to estimating the third predicted pose, based on a time period elapsed between display of consecutive images at the at least one client device, actual time at which a previous third image was displayed at the at least one client device.

10. A method comprising:
receiving, by at least one server from at least one client device, first pose information indicative of at least a pose of the at least one client device over a first time period;
estimating, at the at least one server, a first predicted pose corresponding to a future time instant, based on the first pose information;
generating, at the at least one server, a first image according to the first predicted pose;
receiving, at the at least one server from the at least one client device, second pose information indicative of at least the pose of the at least one client device over a second time period that ends after the first time period;
estimating, at the at least one server, a second predicted pose corresponding to the future time instant, based on the second pose information;
generating, at the at least one server, a second image by reprojecting the first image from the first predicted pose to the second predicted pose using a first reprojection algorithm;
sending the second image from the at least one server to the at least one client device;
collecting, at the at least one client device, third pose information indicative of at least the pose of the at least one client device over a third time period that ends after the second time period;
estimating, at the at least one client device, a third predicted pose corresponding to the future time instant, based on the third pose information;
generating, at the at least one client device, a third image by reprojecting the second image from the second predicted pose to the third predicted pose using a second reprojection algorithm; and
displaying the third image at the at least one client device.

11. The method of claim 10, further comprising:
generating, at the at least one server, a motion vector map corresponding to the second image, based on previously-generated second images, using at least one optical flow algorithm, wherein the motion vector map indicates motion vectors per pixel or per group of pixels;
sending the motion vector map from the at least one server to the at least one client device; and
utilizing, at the at least one client device, the motion vector map with the second reprojection algorithm, to perform a nine degrees-of-freedom (9DOF) reprojection.

12. The method of claim 10 or 11, further comprising:
generating, at the at least one server, a cone angle map based on a depth map corresponding to the second image, wherein the cone angle map indicates cone angles per texel or per group of texels of the depth map, wherein a given cone angle for a given texel or a given group of texels indicates an angle of an imaginary cone whose apex is at the given texel or the given group of texels and within which a given viewing ray can intersect with at most one surface during ray marching;
sending the cone angle map from the at least one server to the at least one client device; and
utilizing, at the at least one client device, the cone angle map with the second reprojection algorithm, to perform ray marching for any of: a six degrees-of-freedom (6DOF) reprojection, a nine degrees-of-freedom (9DOF) reprojection.

13. The method of claim 10, further comprising:
generating, by the at least one server, an acceleration structure based on at least a depth map corresponding to the second image;
sending the acceleration structure from the at least one server to the at least one client device; and
utilizing, at the at least one client device, the acceleration structure with the second reprojection algorithm.

14. The method of claim 10, further comprising:
estimating, at the at least one server, the future time instant as a time instant at which the third image is expected to be displayed at the at least one client device, based on at least one of: a time period elapsed between display of consecutive images at the at least one client device, time at which a previous third image was displayed at the at least one client device; and
refining, at the at least one server, the future time instant prior to estimating the second predicted pose, based on a change in the time at which the previous third image was displayed.

15. The method of claim 10, further comprising refining, at the at least one client device, the future time instant prior to estimating the third predicted pose, based on at least one of: a time period elapsed between display of consecutive images at the at least one client device, actual time at which a previous third image was displayed at the at least one client device.
